(19) United States
(12) Patent Application Publication
(10) Pub. No.: US 2021/0105955 A1
(43) Pub. Date: Apr. 15, 2021

(54) ATMOSPHERE CONTROL SYSTEM FOR AN INDOOR GARDENING APPLIANCE

(71) Applicant: Haier US Appliance Solutions, Inc., Wilmington, DE (US)

(72) Inventors: Michael Goodman Schroeder, Louisville, KY (US); Matthew R. Hunter, Louisville, KY (US); Brian Michael Schork, Louisville, KY (US); Lauren Nicole Platts, Louisville, KY (US)

(21) Appl. No.: 16/600,714

(22) Filed: Oct. 14, 2019

(51) Int. Cl. A01G 9/24

(52) U.S. Cl. CPC A01G 9/24; A01G 9/26

(57) ABSTRACT

An indoor gardening appliance includes a liner defining a grow chamber and a grow module mounted within the grow chamber for receiving a plurality of plant pods. An atmosphere control system includes an air supply source for providing a flow of intake air into the grow chamber. The flow of intake air may pass through an intake duct including permeation membranes for controlling the concentration of gases within the flow of intake air. A gas sensor is used to sense chamber concentrations of various gases and a controller may selectively energize the permeation membranes to control gas concentrations in the flow of intake air, thereby maintaining the chamber concentrations within the desired ranges.

### FIELD OF THE INVENTION

The present subject matter relates generally to systems for gardening plants indoors, and more particularly, to systems and methods for regulating gas concentrations within a grow chamber of an indoor gardening appliance.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature or humidity. Certain indoor garden centers may also include hydration systems for watering the plants and/or artificial lighting systems that provide the light necessary for such plants to grow.

However, conventional indoor gardens centers typically do not include a system for regulating the atmosphere within the grow chamber. For example, plants consume carbon dioxide (CO₂) to facilitate the photosynthesis process, which generates a byproduct of oxygen (O₂). Therefore, the atmosphere within grow chamber may naturally become oxygen-rich and carbon dioxide-deficient. By contrast, other gases may affect the growth rates of plants or within grow chamber, such as nitrogen (N₂) and may be present in undesirable concentrations. Failure to properly regulate these gas concentrations within the atmosphere may result in a sub-optimal growing environment.

Furthermore, conventional indoor garden centers provide no way to regulate the air being discharged from the gardening appliance. In this regard, certain plants may naturally produce a pleasant smell that is preferably discharged to the environment, while others produce a foul smell that is preferably filtered or treated before discharge. Conventional appliances have no means for facilitating the regulation of such discharge air.

Accordingly, an improved indoor garden center would be useful. More particularly, an indoor garden center with an atmosphere control system that regulates gas concentrations within a grow chamber of an indoor garden center would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a gardening appliance is provided including a liner positioned within a cabinet and defining a grow chamber, a grow module mounted within the liner and defining a plurality of apertures, each of the plurality of apertures being configured for receiving a plant pod, and an atmosphere control system. The atmosphere control system includes an air supply source for providing a flow of intake air into the grow chamber, one or more permeation membranes, each of the one or more permeation membranes being configured for adjusting a concentration of one or more gases within the flow of intake air when energized, and a controller operably coupled to the one or more permeation membranes, the controller being configured for selectively energizing the one or more permeation membranes.

In another exemplary embodiment, a method of controlling an atmosphere within a grow chamber of a gardening appliance is provided. The method includes monitoring a chamber concentration of a gas within the grow chamber, determining that the chamber concentration of the gas is outside a desired range, urging a flow of air through one or more permeation membranes and into the grow chamber using an air supply source, and selectively energizing the one or more permeation membranes for adjusting a concentration of the gas within the flow of air to adjust the chamber concentration of the gas to within the desired range.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2 with an internal divider removed for clarity.

FIG. 4 is a top perspective view of the exemplary gardening appliance of FIG. 1, with the top panel of the cabinet removed to reveal a rotatable grow module according to an exemplary embodiment of the present subject matter.

FIG. 5 provides a perspective cross sectional view of the exemplary gardening appliance of FIG. 1 according to another exemplary embodiment of the present subject matter.

FIG. 6 provides a perspective view of the grow module of the exemplary gardening appliance of FIG. 1 according to another exemplary embodiment of the present subject matter.

FIG. 7 provides a perspective cross sectional view of the exemplary grow module of FIG. 6 according to another exemplary embodiment of the present subject matter.

FIG. 8 provides a top cross-sectional view of the exemplary grow module of FIG. 6 according to another exemplary embodiment of the present subject matter.

FIG. 9 provides a schematic view of an atmosphere control system of the exemplary gardening appliance of FIG. 1 according to an exemplary embodiment of the present subject matter.

FIG. 10 provides a method of controlling the atmosphere within a grow chamber of an indoor gardening appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

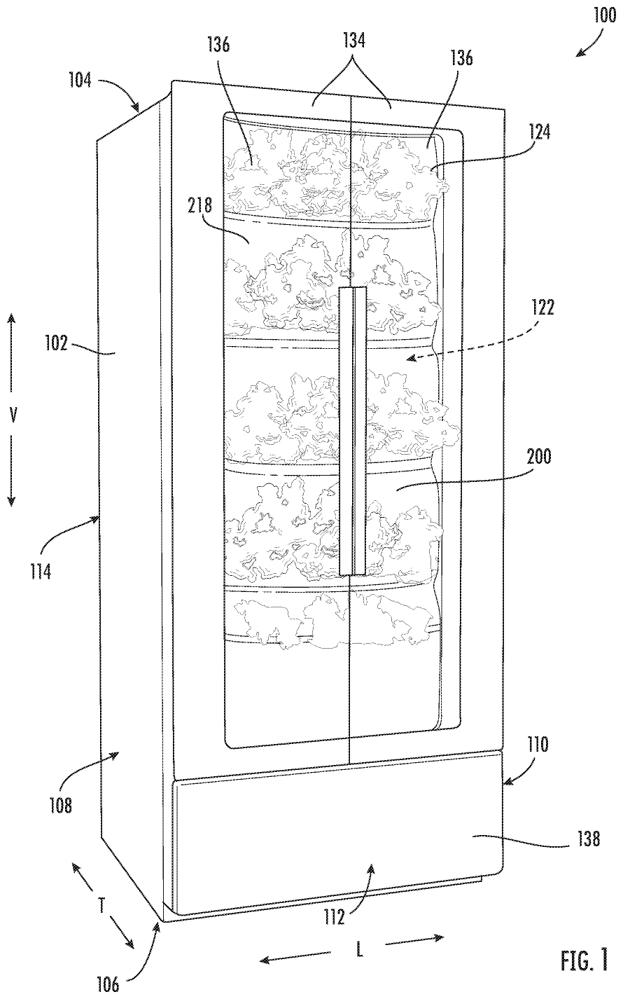

FIG. 1 provides a front view of a gardening appliance 100 according to an exemplary embodiment of the present subject matter. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

Gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 positioned within cabinet 102. Liner 120 may at least partially define a temperature controlled, referred to herein generally as a grow chamber 122, within which plants 124 may be grown. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130. In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

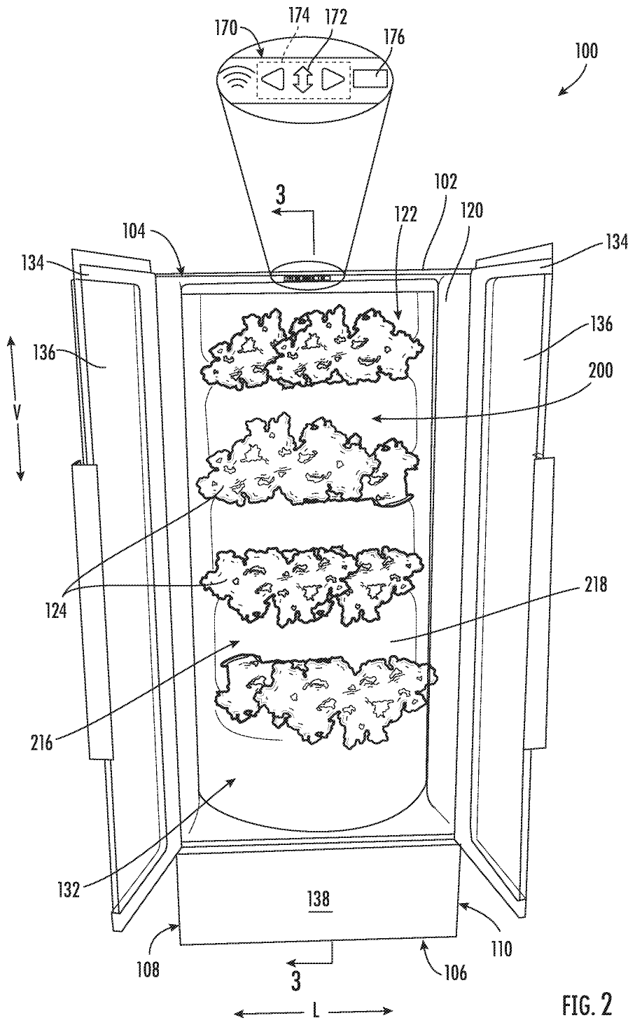

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open positioned for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In addition, behind drawer 138 is a mechanical compartment 140 for receipt of an environmental control system including a sealed system for regulating the temperature within grow chamber 122, as described in more detail below.

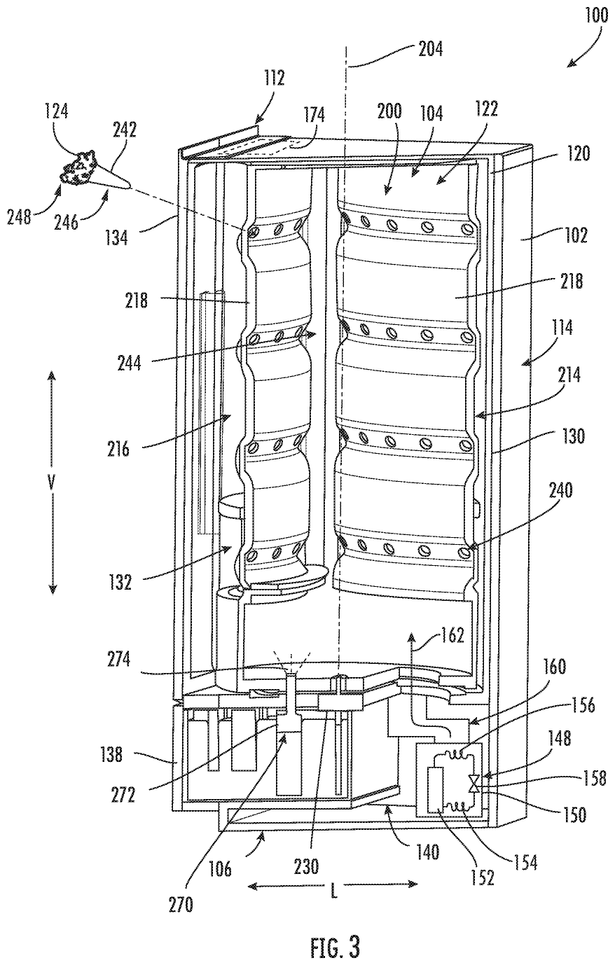

FIG. 3 provides a schematic view of certain components of an environmental control system 148 that may be used to regulate a temperature within grow chamber 122. Specifically, environmental control system 148 may include a sealed system 150, a duct system 160, and a hydration system 270, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high-quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, environmental control system 148 includes a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 are routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122.

Gardening appliance 100 may include a control panel 170. Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, as will be described herein, controller 174 may be communicatively coupled with other components of gardening appliance 100, such as e.g., one or more sensors, motors, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

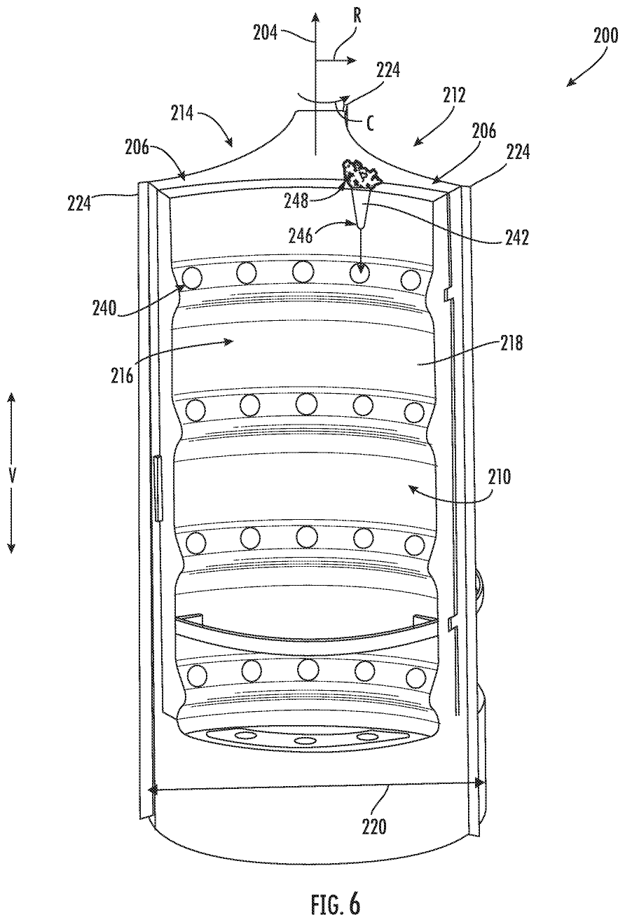

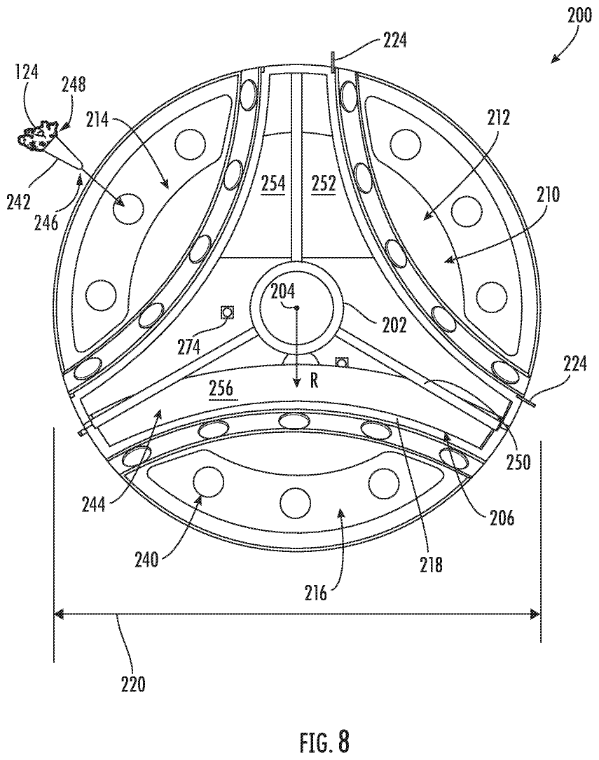

Referring now generally to FIGS. 1 through 8, gardening appliance 100 generally includes a rotatable carousel, referred to herein as a grow module 200 that is mounted within liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g. in a plane perpendicular to central axis 204).

Grow module 200 may further include a plurality of partitions 206 that extend from central hub 202 substantially along the radial direction R. In this manner, grow module 200 defines a plurality of chambers, referred to herein generally by reference numeral 210, by dividing or partitioning grow chamber 122. Referring specifically to a first embodiment of grow module 200 illustrated in FIGS. 1 through 8, grow module 200 includes three partitions 206 to define a first chamber 212, a second chamber 214, and a third chamber 216, which are circumferentially spaced relative to each other. In general, as grow module 200 is rotated within grow chamber 122, the plurality of chambers 210 define substantially separate and distinct growing environments, e.g., for growing plants 124 having different growth needs.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition is joined with an adjacent partition using an arcuate wall 218, which is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

According to still other embodiments, grow module 200 may include one or more sealing elements 224 positioned on a radially distal end of each of partitions 206. In this regard, sealing elements 224 may extend from partitions 206 toward liner 120 to contact and seal against liner 120. For example, according to the illustrated embodiment, sealing elements 224 are wiper blades formed from silicone or another suitably resilient material. Thus, as grow module 200 rotates, sealing elements 224 slide against liner 120 to substantially seal each of the plurality of chambers 210. It should be appreciated that as used herein, the term “substantial seal” and the like is not intended to refer to a perfectly airtight junction. Instead, this term is generally used to refer to an environment which may be regulated independently of adjacent environments to a reasonable degree. For example, if plants 124 and the first chamber 212 prefer a 10° F. increase in temperature relative to plants 124 and second chamber 214, the substantial seal between these two chambers may facilitate such temperature difference.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g. via touch buttons 172), etc. In addition, controller 174 may be communicatively coupled to one or more sensors, such as temperature or humidity sensors, positioned within the various chambers 210 for measuring temperatures and/or humidity, respectively. Controller 174 may then operate motor 230 in order to maintain desired environmental conditions for each of the respective chambers 210. For example, as will be described in more detail below, gardening appliance 100 includes features for providing certain locations of gardening appliance 100 with light, temperature control, proper moisture, nutrients, and other requirements for suitable plant growth. Motor 230 may be used to position specific chambers 210 where needed to receive such growth requirements.

According to an exemplary embodiment, such as where three partitions 206 form three chambers 212-216, controller 174 may operate motor 230 to index grow module 200 sequentially through a number of preselected positions. More specifically, motor 230 may rotate grow module 200 in a counterclockwise direction (e.g. when viewed from a top of grow module 200) in 120° increments to move chambers 210 between sealed positions and display positions. As used herein, a chamber 210 is considered to be in a “sealed position” when that chamber 210 is substantially sealed between grow module 200 (i.e., central hub 202 and adjacent partitions 206) and liner 120. By contrast, a chamber 210 is considered to be in a “display position” when that chamber 210 is at least partially exposed to front display opening 132, such that a user may access plants 124 positioned within that chamber 210.

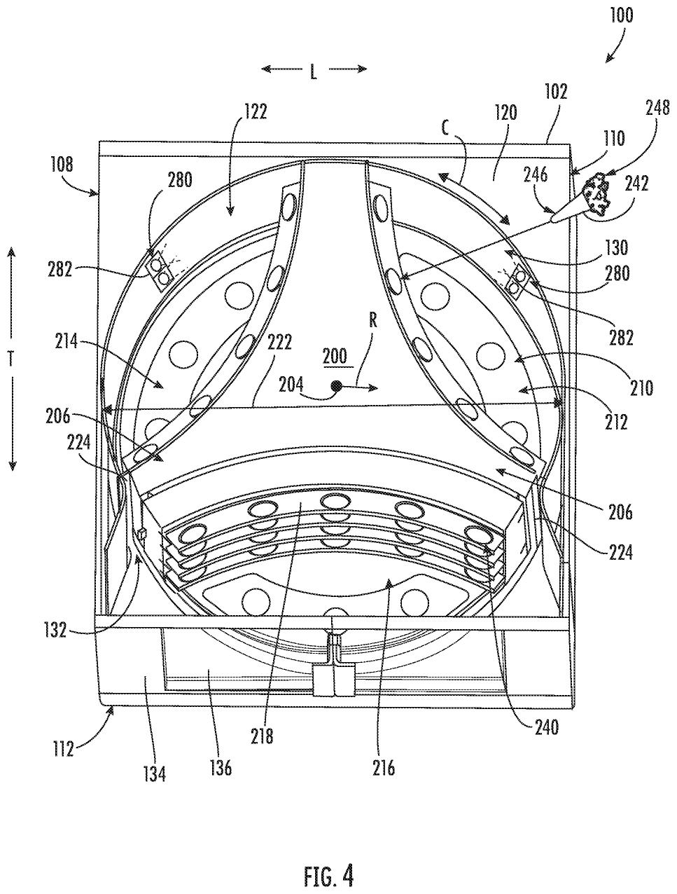

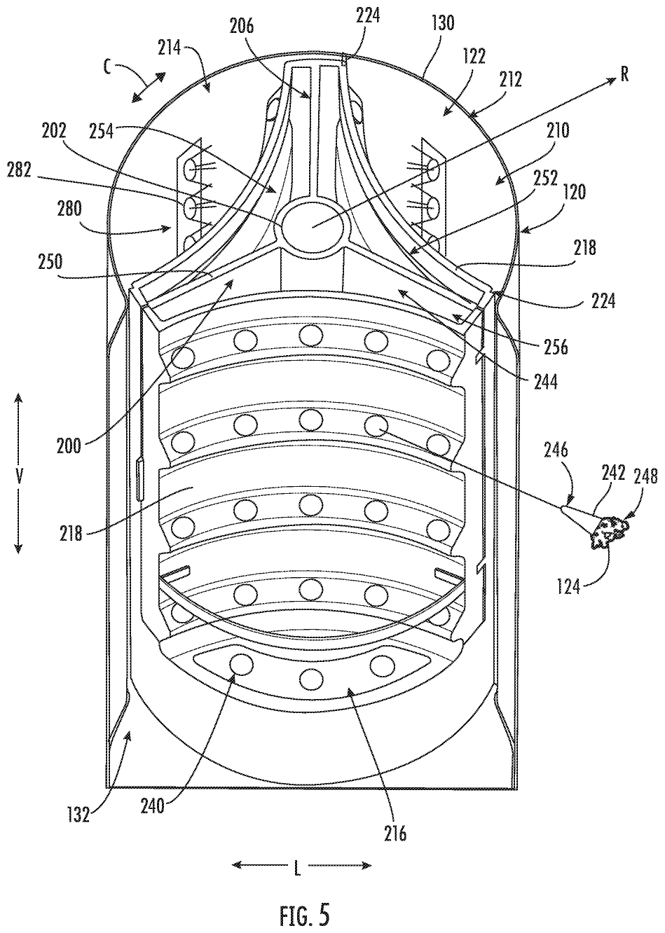

For example, as illustrated in FIGS. 4 and 5, first chamber 212 and second chamber 214 are both in a sealed position, whereas third chamber 216 is in a display position. As motor 230 rotates grow module 200 by 120 degrees in the counterclockwise direction, second chamber 214 will enter the display position, while first chamber 212 and third chamber 216 will be in the sealed positions. Motor 230 may continue to rotate grow module 200 in such increments to cycle grow chambers 210 between these sealed and display positions.

Referring now generally to FIGS. 4 through 8, grow module 200 will be described in more detail according to an exemplary embodiment of the present subject matter. As shown, grow module 200 defines a plurality of apertures 240 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of apertures 240 into root chamber 244. A plant end 248 of the plant pod 242 may remain within grow chamber 210 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, apertures 240 may be covered by a flat flapper seal (not shown) to prevent water from escaping root chamber 244 when no plant pod 242 is installed.

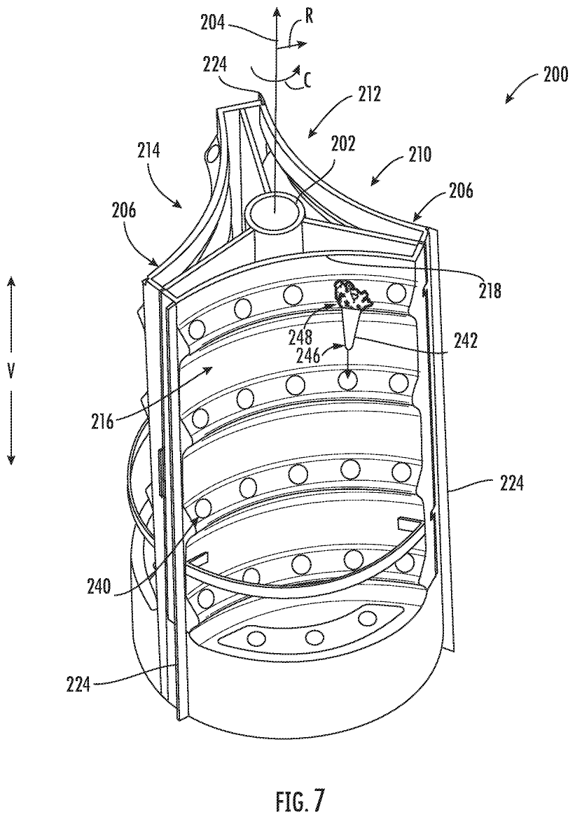

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of grow chambers 210 through the plurality of apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in the first grow chamber 212, second root chamber 254 may provide water and nutrients to plants 124 positioned in the second grow chamber 214, and third root chamber 256 may provide water and nutrients to plants 124 positioned in the third grow chamber 216. In this manner, environmental control system 148 may control the temperature and/or humidity of each of the plurality of chambers 212-216 and the plurality of root chambers 252-256 independently of each other.

Environmental control system 148 may further include a hydration system 270 which is generally configured for providing water to plants 124 to support their growth. Specifically, according to the illustrated embodiment, hydration system 270 generally includes a water supply 272 and misting device 274 (e.g., such as a fine mist spray nozzle or nozzles). For example, water supply 272 may be a reservoir containing water (e.g., distilled water) or may be a direct connection municipal water supply. Misting device 274 may be positioned at a bottom of root chamber 244 and may be configured for charging root chamber 244 with mist for hydrating the roots of plants 124. Alternatively, misting devices 274 may pass through central hub 204 along the vertical direction V and periodically include a nozzle for spraying a mist or water into root chamber 244. Because various plants 124 may require different amounts of water for desired growth, hydration system 270 may alternatively include a plurality of misting devices 274, e.g., all coupled to water supply 272, but being selectively operated to charge each of first root chamber 252, second root chamber 254, and third root chamber 256 independently of each other.

Notably, environmental control system 148 described above is generally configured for regulating the temperature and humidity (e.g., or some other suitable water level quantity or measurement) within one or all of the plurality of chambers 210 and/or root chambers 252-256 independently of each other. In this manner, a versatile and desirable growing environment may be obtained for each and every chamber 210.

Referring now for example to FIGS. 4 and 5, gardening appliance 100 may further include a light assembly 280 which is generally configured for providing light into selected grow chambers 210 to facilitate photosynthesis and growth of plants 124. As shown, light assembly 280 may include a plurality of light sources 282 stacked in an array, e.g., extending along the vertical direction V. For example, light sources 282 may be mounted directly to liner 120 within grow chamber 122, or may alternatively be positioned behind liner 120 such that light is projected through a transparent window or light pipe into grow chamber 122. The position, configuration, and type of light sources 282 described herein are not intended to limit the scope of the present subject matter in any manner.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

As explained above, light generated from light assembly 280 may result in light pollution within a room where gardening appliance 100 is located. Therefore, aspects of the present subject matter are directed to features for reducing light pollution, or to the blocking of light from light sources 282 through front display opening 132. Specifically, as illustrated, light assembly 280 is positioned only within the enclosed back portion 130 of liner 120 such that only grow chambers 210 which are in a sealed position are exposed to light from light sources 282. Specifically, grow module 200 acts as a physical partition between light assemblies 280 and front display opening 132. In this manner, as illustrated in FIG. 5, no light may pass from first chamber 212 or second chamber 214 through grow module 200 and out front display opening 132. As grow module 200 rotates, two of the three grow chambers 210 will receive light from light assembly 280 at a time. According still other embodiments, a single light assembly may be used to reduce costs, whereby only a single grow chamber 210 will be lit at a single time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first grow chamber and a second grow chamber. According to such an embodiment, by rotating grow module 200 by 180 degrees about central axis 206, the first chamber may alternate between the sealed position (e.g., facing rear side 114 of cabinet 102) and the display position (e.g., facing front side 112 of cabinet 102). By contrast, the same rotation will move the second chamber from the display position to the sealed position.

According to still other embodiments, gardening appliance 100 may include a three chamber grow module 200 but may have a modified cabinet 102 such that front display opening 132 is wider and two of the three grow chambers 210 are displayed at a single time. Thus, first chamber 212 may be in the sealed position, while second chamber 214 and third chamber 216 may be in the display positions. As grow module 200 is rotated counterclockwise, first chamber 212 is moved into the display position and third chamber 216 is moved into the sealed position.

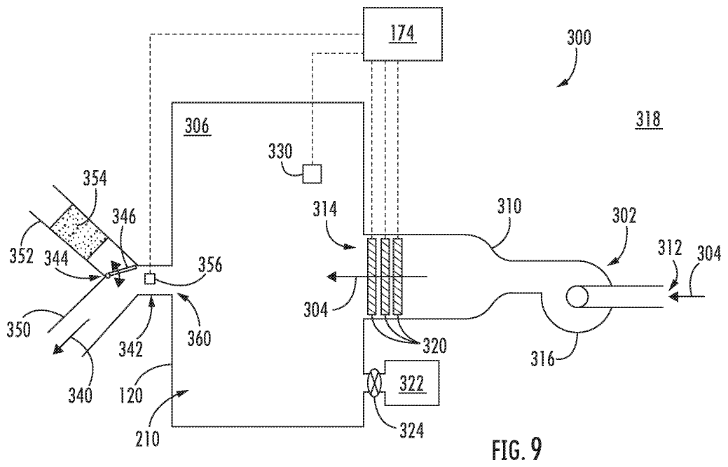

Referring now specifically to FIG. 9, an atmosphere control system 300 that may be used to regulate the atmosphere in and around gardening appliance 100 will be described according to exemplary embodiments of the present subject matter. As explained above, the growth rates and health of plants grown within gardening appliance 100 are dependent upon the concentrations of gases contained therein. In addition, certain plants produce foul or pleasant smells that should be appropriately filtered and/or discharged. Aspects of the present subject matter are directed to an atmosphere control system that is designed for regulating such flows of air and controlling the atmosphere within grow chamber 210. Although exemplary configurations are described herein, it should be appreciated that atmosphere control system 300 may vary while remaining within the scope of the present subject matter.

According to the illustrated embodiment, atmosphere control system 300 includes an air supply source 302 for providing a flow of intake air (e.g., identified by arrows 304) into grow chamber 210. This flow of intake air 304 may enter grow chamber 210 and mix with the air present within grow chamber 210 (i.e., chamber air as identified generally by reference numeral 306). Notably, the concentration of various gases within chamber air 306 may be varied by regulating the concentrations of the same gases within the flow of intake air 304. Thus, aspects of the present subject matter are directed to the regulation of the flow of intake air 304 and the gas concentrations thereof.

Specifically, the flow of intake air 304 may pass into grow chamber 210 through an intake duct 310. More specifically, air supply source 302 may be fluidly coupled to or positioned within an inlet 312 of inlet duct 310 for urging the flow of intake air 304 therethrough. An outlet 314 of inlet duct 310 may be fluidly coupled to grow chamber 210. Notably, air supply source 302 may generally be any suitable source of air or other gases suitable for introduction into grow chamber 210 to facilitate plant growth. For example, according to the illustrated embodiment, air supply source 302 is an air pump 316 that is fluidly coupled to intake duct 310 for drawing in air from an ambient environment 318 (e.g., surrounding gardening appliance 100) and urging the flow of intake air 304 into grow chamber 210.

In order to regulate the gas concentrations within the flow of intake air 304, atmosphere control system 300 may further include one or more permeation membranes 320 that are configured for adjusting a concentration of one or more gases within the flow of intake air 304. For example, permeation membranes 320 are membranes through which the flow of intake air 304 may pass, but which may be selectively energized, electrified, or placed within a magnetic field to control the gas concentrations that pass therethrough. For example, the permeation membranes 320 may be selected to adjust a concentration of a particular gas such as, for example, oxygen (02), carbon dioxide (CO₂), or nitrogen (N₂).

Atmosphere control system 300 may include a controller, such as a dedicated controller or controller 174 of indoor garden appliance 100, that may be operably coupled to permeation membranes 320 for selectively energizing one or more of the permeation membranes 320 to adjust the gas concentrations within the flow of intake air 304. In this manner, by adjusting the operation of air pump 316 and the energization of permeation membranes 320, controller 174 may manipulate or regulate the concentration of the gases within chamber air 306.

It should be appreciated that variations and modifications may be made to permeation membranes 320 and the flow control structure of atmosphere control system 300 while remaining within scope of the present subject matter. For example, according to the illustrated embodiment, atmosphere control system 300 includes three permeation membranes 320 (e.g., for regulating O₂, CO₂, and N₂) that are stacked adjacent each other within intake duct 310. However, according to alternative embodiments, permeation membranes 320 may be positioned at different locations around cabinet 102 or liner 120 for regulating the flow of gas therethrough. In addition, air pump 316 may not be required in air supply source 302 may rely solely on natural flows of air into grow chamber 210.

According to still other embodiments, atmosphere control system 300 may include an auxiliary gas source 322 that is fluidly coupled to grow chamber 210. According to such an embodiment, auxiliary gas source 322 may contain a concentrated gas of a desired composition, such as pure carbon dioxide (CO₂), nitrogen (N₂), etc. A control valve 324 may regulate the flow of such concentrated gas from auxiliary gas source 322 into grow chamber 210. According to exemplary embodiments, such an auxiliary gas source 322 may be used, e.g., in situations where the gas concentrations within chamber air 306 fall far from the desired ranges and a quick adjustment is needed.

In order to monitor the gas concentrations within chamber air 306, atmosphere control system 300 may further include a gas sensor 330 that is positioned within grow chamber 310 for detecting such concentrations. Thus, according to an exemplary embodiment, controller 174 is a communicatively coupled with gas sensor 330 and is configured for selectively energizing permeation membranes 320 based at least in part on the concentrations detected by gas sensor 330. In this manner, gas sensor 330 may provide feedback to achieve an accurate gas concentration and ideal growing atmosphere within grow chamber 210.

In addition to regulating the flow of intake air 304, atmosphere control system 300 may include features for regulating the discharge air (e.g., identified herein generally by reference numeral 340). In this regard, according to the illustrated embodiment, atmosphere control system 300 includes a discharge duct 342 that is in fluid communication with grow chamber 210 for permitting the flow of discharge air 340 to exit grow chamber 210. In addition, a flow regulating device 344 may be operably coupled to the discharge duct 342 to regulate the flow of discharge air 340. According to an exemplary embodiment, flow regulating device 344 is a damper 346 that pivots between positions to control the flow of discharge air 340, as described below. However, it should be appreciated that flow regulating device 344 may be any other suitable flow control device.

According to the illustrated embodiment, discharge duct 342 is split into an unfiltered portion 350 and a filtered portion 352. In addition, damper 346 pivots between a first position (e.g. as shown in FIG. 9) to direct discharge air 340 through unfiltered portion 350 directly to the ambient environment 318 and a second position (not shown) for directing discharge air 340 through filtered portion 352. Notably, filtered portion 352 may further include a filter element or filter device 354 for treating, filtering, or conditioning the flow of discharge air 340, as described in more detail below.

Referring still to FIG. 9, atmosphere control system 300 may include an odor sensor 356 which is generally configured for detecting pleasant or foul odors, levels of volatile organic compounds (VOCs), or other scent-related characteristics of the flow of discharge air 340. Controller 174 may be operably coupled with odor sensor 356 and may regulate the position of damper 346 based on the odors detected. For example, if odor sensor 356 detects high levels of VOCs or bad smells, damper 346 may be shifted to the second position for directing the flow of discharge air 340 through filtered portion 352, and more particularly, through filter device 354. In this manner, harmful VOCs or bad smells may be removed from the flow of discharge air 340 prior to discharging to ambient environment 318. By contrast, if pleasant smells or low VOCs are detected, damper 346 may be controlled to directly discharge the discharge air 340 through unfiltered portion 350.

Notably, outlet 314 of intake duct 310 may be positioned at any suitable location for supplying the flow of intake air 304 into grow chamber 210. For example, as illustrated schematically in FIG. 9, outlet 314 is positioned directly within a side wall of liner 120. In addition, the flow of intake air 304 may be provided into a single chamber that is in the sealed position (e.g., first chamber 212), into both chambers that are in a sealed position (e.g., first chamber 212 and second chamber 214), into third chamber 216 in the display position, or any other suitable location. According to still other embodiments, it should be appreciated that according to alternative embodiments, outlet 314 of intake duct 310 may be fluidly coupled to root chamber 244.

Similarly, an inlet 360 of discharge duct may be positioned at any suitable location. For example, according to one exemplary embodiment, outlet 314 of intake duct 310 is positioned within first chamber 212 while inlet 360 of discharge duct 342 is positioned within the second chamber 214. According to still other embodiments, multiple intake ducts, and multiple discharge ducts may be used independently to regulate gas concentrations within each of chambers 212-216. Other configurations are possible and within the scope of the present subject matter.

Now that the construction of gardening appliance 100 has been described according to exemplary embodiments, an exemplary method 400 of regulating the atmosphere within an indoor garden appliance will be described. Although the discussion below refers to the exemplary method 400 of operating gardening appliance 100, one skilled in the art will appreciate that the exemplary method 400 is applicable to the operation of a variety of other gardening appliances and/or atmosphere control systems or assemblies.

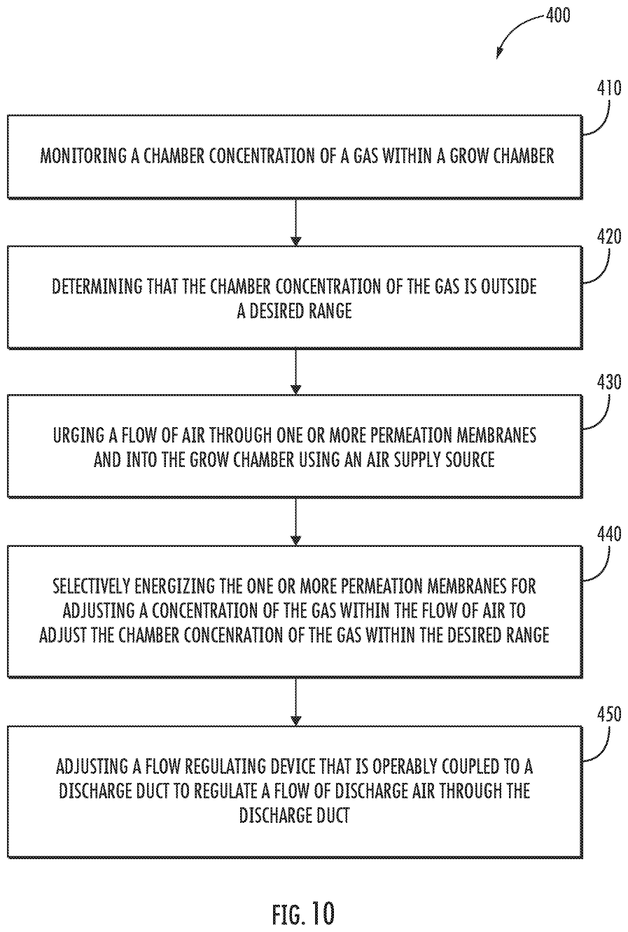

Referring now to FIG. 10, method 400 includes, at step 410, monitoring a chamber concentration of a gas within a grow chamber. For example, continuing the example from above, atmosphere control system 300 may use gas sensor 330 to detect the concentrations of certain specific gases within chamber air 306. Controller 174 may further be configured for obtaining desired gas concentrations of such gases or desired ranges of such gases, e.g., based on a particular plant 124 being grown. Step 420 can further include determining that the chamber concentration of the gases outside of the desired range. When such gas concentrations fall outside the desired range, atmosphere control system 300 may implement corrective action by introducing the flow of intake air 304 to correct such gas concentrations.

Specifically, step 430 includes urging the flow of air through one or more permeation membranes and into the grow chamber using an air supply source. For example, as described above, air pump 316 may draw in air from the ambient environment 318 and urge that air through inlet duct 310. The flow of intake air 304 may pass through a plurality of permeation membranes 320, each of which may be configured for regulating the flow of a specific gas or increasing a concentration of that specific gas.

In addition, step 440 includes selectively energizing the one or more permeation membranes for adjusting a concentration of the gas within the flow of air to adjust the chamber concentration of the gas to within the desired range. Specifically, controller 174 may further selectively energize or electrify each of the permeation membranes 320 to control the total gas concentrations within the flow of intake air 304. The flow of intake air 304 may pass into grow chamber 210 and mix with chamber air 306 to result in new concentrations closer to the desired range or target concentrations. In the event the gas concentrations of chamber air 306 cannot be moved into the desired range, atmosphere control system 300 may further use an auxiliary gas source 322 and control valve 324 to supplement such gas in order to reach the target gas concentrations for desired or improved plant growth.

Step 450 may further include adjusting a flow regulating device that is operably coupled to a discharge duct to regulate a flow of discharge air through the discharge duct. For example, as explained above according to an exemplary embodiment, damper 346 may be used to control the flow of air through discharge duct 342. For example, damper 346 may direct discharge air 340 through an unfiltered portion 350 when there are low VOCs or pleasant smells. By contrast, if plants are being grown within indoor garden appliance 100 that are generating foul smells or high VOCs, damper 346 may be adjusted to direct discharge air 340 through filtered portion 352 and filter device 354 for lowering the VOCs or improving the smells. According still other embodiments, damper 346 may be configured for completely shutting off or closing discharge duct 342. According to alternative embodiments, variations and modifications may be made to the operation of damper 346, the type of filter device 354, the desired gas concentration ranges, etc.

FIG. 10 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of method 400 are explained using gardening appliance 100 as an example, it should be appreciated that these methods may be applied to the operation of any gardening appliance or atmosphere control systems having any other suitable configuration.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance, comprising:
a liner positioned within a cabinet and defining a grow chamber;
a grow module mounted within the liner and defining a plurality of apertures, each of the plurality of apertures being configured for receiving a plant pod; and
an atmosphere control system comprising:
an air supply source for providing a flow of intake air into the grow chamber;
one or more permeation membranes, each of the one or more permeation membranes being configured for adjusting a concentration of one or more gases within the flow of intake air when energized; and
a controller operably coupled to the one or more permeation membranes, the controller being configured for selectively energizing the one or more permeation membranes.

2. The gardening appliance of claim 1, further comprising:
an intake duct fluidly coupled to the grow chamber, wherein the one or more permeation membranes are positioned within the inlet duct.

3. The gardening appliance of claim 2, wherein the air supply source comprises an air pump fluidly coupled to the intake duct.

4. The gardening appliance of claim 1, further comprising:
a gas sensor positioned in the grow chamber for detecting a concentration of one or more gases in the grow chamber, the controller being configured for selectively energizing the one or more permeation membranes based at least in part on the concentration detected by the gas sensor.

5. The gardening appliance of claim 1, wherein the one or more permeation membranes are selected to adjust the concentration of at least one of oxygen (O₂), carbon dioxide (CO₂), or nitrogen (N₂) in the flow of intake air.

6. The gardening appliance of claim 1, wherein the one or more permeation membranes comprise a plurality of permeation membranes stacked adjacent each other, each of the plurality of permeation membranes being configured for increasing the concentration of at least one of the one or more gases.

7. The gardening appliance of claim 1, further comprising:
an auxiliary gas source fluidly coupled with the grow chamber for providing concentrated gas of a desired composition into the grow chamber.

8. The gardening appliance of claim 1, further comprising:
a discharge duct in fluid communication with the grow chamber for permitting a flow of discharge air to exit the grow chamber; and
a flow regulating device operably coupled to the discharge duct to regulate the flow of discharge air through the discharge duct.

9. The gardening appliance of claim 8, wherein the discharge duct is split into a filtered portion and an unfiltered portion, wherein the flow regulating device selectively directs the flow of air through the filtered portion or the unfiltered portion.

10. The gardening appliance of claim 9, further comprising:
an air filter device positioned within the filtered portion of the discharge duct.

11. The gardening appliance of claim 8, further comprising:
an odor sensor, wherein the controller is operably coupled to the odor sensor and the flow regulating device, the controller being configured for directing the flow of air through the filtered portion based at least in part on feedback from the odor sensor.

12. The gardening appliance of claim 8, wherein the flow regulating device is a damper.

13. The gardening appliance of claim 1, wherein the grow module comprising a central hub rotatable about an axis and a plurality of partitions extending from the central hub substantially along a radial direction to define a plurality of grow chambers spaced apart along a circumferential direction.

14. The gardening appliance of claim 13, wherein an outlet of the intake duct is positioned within a first chamber of the plurality of grow chambers, and wherein an inlet of the discharge duct is positioned within a second chamber of the plurality of grow chambers.

15. The gardening appliance of claim 1, wherein the grow module defines an internal root chamber, and wherein the intake duct is fluidly coupled to the root chamber.

16. A method of controlling an atmosphere within a grow chamber of a gardening appliance, the method comprising:
monitoring a chamber concentration of a gas within the grow chamber;
determining that the chamber concentration of the gas is outside a desired range;
urging a flow of air through one or more permeation membranes and into the grow chamber using an air supply source; and
selectively energizing the one or more permeation membranes for adjusting a concentration of the gas within the flow of air to adjust the chamber concentration of the gas to within the desired range.

17. The method of claim 16, wherein the one or more permeation membranes are selected to adjust the concentration of at least one of oxygen (O₂), carbon dioxide (CO₂), or nitrogen (N₂) in the flow of air.

18. The method of claim 16, further comprising:
detecting a concentration of one or more gases in the grow chamber using a gas sensor positioned in the grow chamber; and
selectively energizing the one or more permeation membranes based at least in part on the concentration detected by the gas sensor.

19. The method of claim 16, further comprising:
adjusting a flow regulating device that is operably coupled to a discharge duct to regulate a flow of discharge air through the discharge duct.

20. The method of claim 16, further comprising:
obtaining feedback from an odor sensor positioned within a discharge duct; and
adjusting a flow regulating device to direct the flow of discharge air through a filtered portion of the discharge duct based at least in part on feedback from the odor sensor.
